(19) United States
(12) Patent Application Publication
(10) Pub. No.: US 2012/0267905 A1
(43) Pub. Date: Oct. 25, 2012

(54) LOCK FOR MOTOR VEHICLE OPENING LEAF FITTED WITH A SPRING

(75) Inventor: François Debroucke, Creteil Cedex (FR)

(73) Assignee: VALEO SECURITE HABITACLE, Créteil Cedex (FR)

(21) Appl. No.: 13/510,018

(22) PCT Filed: Dec. 2, 2010
(86) PCT No.: PCT/EP2010/068707

§ 371 Date: Jun. 26, 2012

(30) Foreign Application Priority Data
Dec. 8, 2009 (FR) 09/05949

(51) Int. Cl. E05B 65/20; E05B 15/04

(52) U.S. Cl. 292/336.3

(57) ABSTRACT

The system (2) for an opening leaf (22) of a vehicle comprises: at least one upstream member (60), at least one spring (162), and at least one downstream member (64) capable of causing the opening leaf to open. The spring extends in series between the upstream member and the downstream member with reference to a kinematic chain along which a command to open the opening leaf is transmitted from the upstream member to the downstream member.

The invention concerns vehicle opening leaf locks.

The locks of a vehicle opening leaf usually comprise a large number of parts notably enabling opening of the opening leaf either from the exterior of the vehicle or from the interior. Among the latter, each of the exterior and interior handles is able to drive rotation of the same intermediate lever that comes to bear against a dummy pawl and causes the bolt to be separated from the keeper of the lock, thus releasing the opening leaf.

During the opening maneuver, the user, when actuating one of the handles, exerts a force the intensity of which increases very rapidly and then decreases as soon as the pawl has released the bolt which itself has released the keeper. The trend of this force curve is that of a spike and the sensation felt is similar to an impact. This rising intensity trend is explained by the fact that the user must cause the parts to travel a certain number of dead strokes, and then to overcome the forces provided by the return springs of the mechanism and finally to provide the highest force to release the pawl that in turn releases the bolt from the keeper. However, this sensation of impact, even if it is the norm, is relatively disagreeable.

An object of the invention is to improve the comfort of the user on opening the opening leaf.

To this end the invention provides an opening system for vehicle opening leaf, characterized in that it comprises:
at least one upstream member,
at least one spring, and
at least one downstream member adapted to command opening of the opening leaf,
   the spring extending in series between the upstream member and the downstream member with reference to a kinematic chain for transmitting a command to open the opening leaf from the upstream member to the downstream member.

Accordingly, at the time of the action of the user on the handle, the force exerted before the pawl is maneuvered is devoted in part to loading the spring inserted in series. The spring thus implies a greater prior increase in force during the opening movement. The user must consequently increase the force sooner than in the aforementioned prior art. This leads to increased spreading over time of this increase in intensity, with a force in the form of a ramp. Although the final force to be exerted is thus substantially the same, the progress toward it begins sooner so that the user does not experience a spike or an impact on maneuvering the handle but to the contrary an earlier and more regular increase in intensity. This makes the maneuver more comfortable.

The system is preferably such that the upstream member transmits the opening command to the downstream member only via the spring or springs.

Accordingly, the force is transmitted via the spring alone and not by direct contact between the members between which it is disposed in the kinematic chain. Once a certain level of loading of the spring has been achieved, the spring transmits the forces that it receives at its upstream end to the downstream member, i.e. by balancing of the forces.

In one embodiment, the system is such that the upstream member is able to come to bear directly against the downstream member to transmit to it the opening command.

Thus in ordinary operation the loading of the spring may be merely a preliminary to the bringing of the parts into contact with a view to direct transmission of the loads from one to the other to command opening of the opening leaf. This also produces an early and progressive increase in force. However, it will be preferable to reserve such operation to a so-called degraded mode that will be encountered for example in a system conforming to the aforementioned embodiment but in which the spring is so fatigued that it has become insufficient on its own to transmit the loading from one part to the other or in a standby mode in the situation where the necessary load on the pawl is too high, notably in the case of opening after a crash.

Alternatively or cumulatively, the spring or at least one of the springs may extend:
between two rotary levers of the lock;
in a part of the kinematic chain commandable only from an exterior handle of the opening leaf;
between a handle and a first rotary lever that follows the handle in the kinematic chain;
upstream of a cable of the lock;
between two levers upstream of a cable of the lock;
between two sections of a cable of the lock;
downstream of a cable of the lock; and
between a clutch lever of the lock and a lever of the lock upstream of the clutch lever.

Other features and advantages of the invention will become more apparent in the following description of two embodiments and variants given by way of nonlimiting example and with reference to the appended drawings, in which:

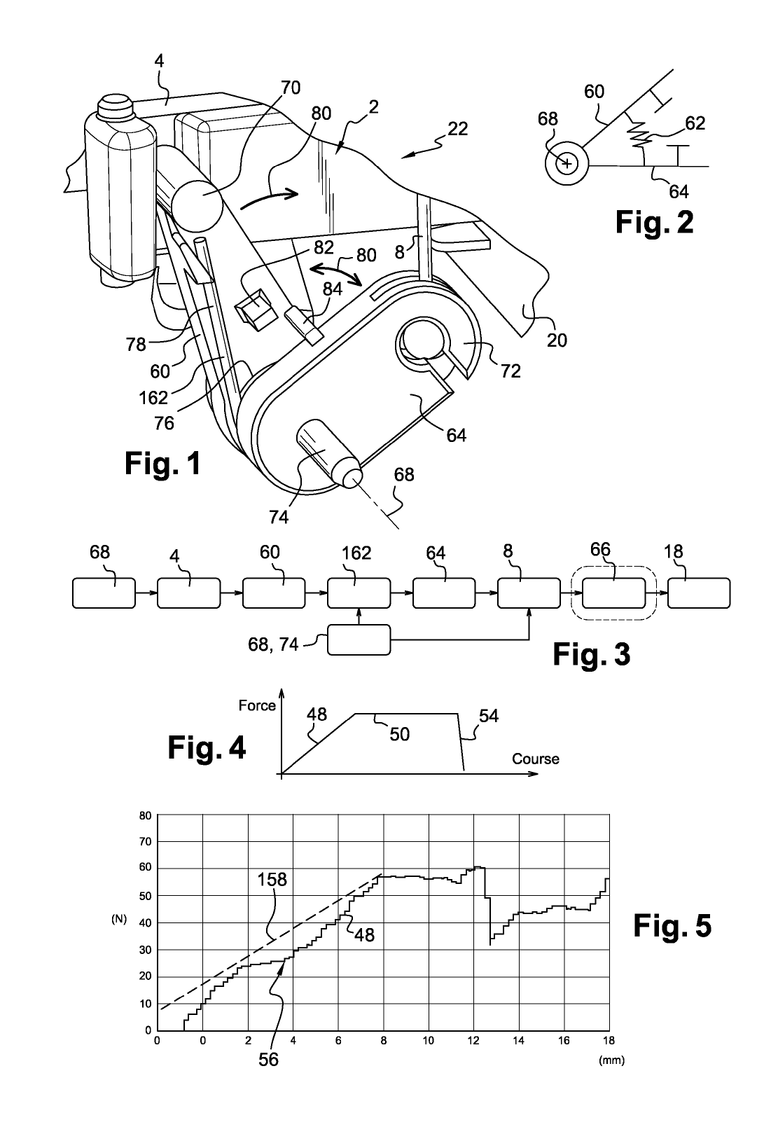

FIG. 1 is a partial perspective view of a lock of a first embodiment of the invention;

FIG. 2 is a diagram showing the arrangement of two parts of this lock between which a spring is disposed;

FIG. 3 is a diagram of the kinematic chain of the FIG. 1 lock;

FIG. 4 is a general curve of the changing intensity of the force exerted by the user as a function of the stroke of the handle during the maneuver of opening the FIG. 1 lock;

FIG. 5 is a view analogous to FIG. 4;

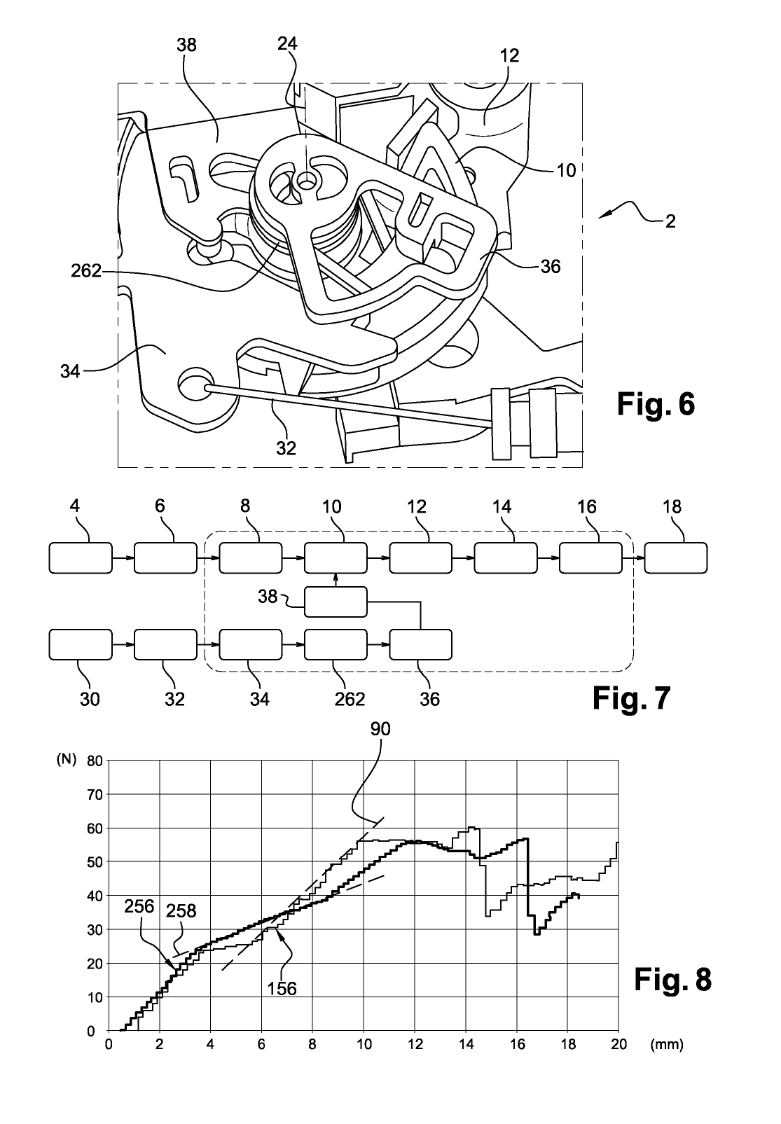

FIG. 6 is a partial perspective view of a lock of a second embodiment of the invention; and

FIGS. 7 and 8 are views analogous to FIGS. 3 and 5 concerning the FIG. 6 lock.

There will be described with reference to FIGS. 1 and 2 a lock 2 for an automobile vehicle opening leaf 22 conforming to a first embodiment of the invention. The opening leaf is for example a door. Some parts of the lock referred to hereinafter are of a classic type and are not described in detail and/or shown. For more details of some aspects of the lock, see for example the document EP-1 158 124 in the name of the applicant.

The system comprises the following members that are adapted to maneuver each other successively in the order in which they are listed hereinafter to transmit a command to open the opening leaf, thus forming a kinematic chain:
an opening handle 4,
a transfer lever 60,
an opening spring 162,
an output lever 64,
an interior opening cable 8,
a mechanism 66, and
a keeper 18.

The mechanism 66 of the second embodiment includes among others the following elements described by way of example:
an intermediate opening lever 10,
a dummy pawl 12,
a pawl 14, and
a bolt 16 intended to cooperate with the keeper 18.

FIG. 3 shows at the head of the kinematic chain the hand 68 of the user who is actuating the handle 4.

The two levers 60 and 64 are mounted to be mobile in rotation relative to a frame 20 of the opening leaf 22 about a common rotation axis 68. The axis 68 is near a proximal end of each lever. A distal end 70 of the lever 60 cooperates directly with the handle 4 while a distal end 72 of the lever 64 cooperates directly with an end of the cable 8.

The axis 68 is materialized by a shaft 74. The two levers 60, 64 are successively threaded over the shaft in the longitudinal direction of the axis 68. In this direction there is disposed between the two levers a spring 162 which here is a torsion coil spring, thus comprising a helicoidal median part 76 and two rectilinear end branches 78 only one of which is visible in FIG. 1. The branch 78 bears in a direction circumferential to the axis 68 on a relief 69 of the lever 70. Similarly, the other end of the spring bears in the circumferential direction against a relief of the lever 72 but in the opposite direction to the bearing engagement associated with the lever 70. The spring 162 thus tends to cause the levers to turn relative to each other, moving them apart in the direction of the two-headed arrow 80.

The two levers carry respective reliefs 82 and 84 adapted to come into contact with each other in the circumferential direction when the levers are moved toward each other against the return force developed by the spring 162.

The opening leaf is opened in the following manner.

It is assumed that the hand 68 of the user actuates the handle 4, which causes the transfer lever 60 to turn about the axis 68 in the direction of the arrow 80 in FIG. 1, to move it toward the output lever 64. The beginning of the maneuvering of the lever 60 serves to load the spring 76 the branch 78 of which is first moved towards the other branch without the lever 64 being moved. As long as the load on the handle has not generated a sufficient load in the spring, the lever 64 remains immobile. This phase of the movement is illustrated by the section 48 of the curve shown in FIG. 4. Over this section, the intensity of the force exerted by the user increases regularly as a function of the stroke of the handle until it reaches a level that will enable movement of the lever 64. The section 48 corresponds so to speak to a phase during which the spring 162 is armed, and forms an increasing force ramp.

At this stage, where the second section 50 of the curve begins, the spring 162 is now loaded with an intensity that exceeds the mechanical resistance forces of the downstream portion of the kinematic chain. The lever 60 thus now drives rotation of the lever 64 about the axis in the same direction 80. The maneuvering of the handle 4 is thus transmitted by these parts to the cable 8, and then to the mechanism 66 to separate the bolt from the keeper 18 and enable opening of the opening leaf. Up to opening of the opening leaf, it is the section 50 of the FIG. 4 curve that represents this phase of the maneuver. It is effected substantially at constant force intensity because the spring has been chosen for this purpose, namely to have a stiffness such that the user has no need to increase significantly the intensity of their force over this section.

During the last section 54, the intensity of the force decreases in that the pawl is unlocked from the bolt, and thus from the keeper.

In this embodiment, the spring 162 is very far upstream in the kinematic chain, which makes it possible to reduce the effects of losses of efficiency. Also reduced are the plateau phases caused by the dead strokes of the movement of some parts.

FIG. 5 shows a curve 56 derived from experimental results for a prior art lock and a straight line segment 158 indicating the smoothing obtained compared to the FIG. 1 lock. It is seen that, in addition to the effect of smoothing the intensity of the force that it generates, this straight line segment is only slightly inclined relative to the horizontal direction. The increase in force is thus early, regular and relatively slow in the section 48.

In degraded mode, if the spring 162 proves insufficient on its own, for example because of excessive fatigue of the material, or because of exceptional resistance, notably after a crash, to transmit a loading from the lever 60 to the lever 64, the lever 60 as it moves comes into contact via the relief 82 with the relief 84 of the lever 64. This direct bearing engagement enables movement of the lever 64 by means of the lever 60. As the spring must nevertheless be loaded before bringing the levers into contact, there is seen again an increasing force portion of the ramp.

A second embodiment of the invention will now be described with reference to FIGS. 6 to 8. This time the system comprises the following members that are adapted to maneuver each other successively in the order in which they are listed hereinafter to transmit a command to open the opening leaf, thus forming a kinematic chain:
an opening handle 4,
an interior cable 6,
an interior opening lever 8,
an intermediate opening lever 10,
a dummy pawl 12,
a pawl 14,
a bolt 16, and
a keeper 18.

The handle 4 is rotatably mounted relative to the frame 20 of the opening leaf 22. It actuates, via the cable 6, the interior opening lever 8, which is rotatably mounted. The latter actuates the intermediate opening lever 10 which is also rotatably mounted relative to the frame 20 about an axis 24. The dummy pawl 12 and the pawl 14 are rotatably mounted relative to the frame 20 about the same axis, but are mobile relative to each other. The axes 24 and 26 are spaced from and parallel to each other.

The system also comprises the following members that are adapted to maneuver each other successively in the order in which they are listed hereinafter to transmit a command to open the opening leaf, thus forming a kinematic chain:
an exterior handle 30,
an exterior cable 32,
an exterior opening lever 34,
an opening spring 262, and
a clutch lever 36.

Accordingly, the exterior handle 30 is fixed to one end of the cable 32, the other end of which is fixed to the exterior opening lever 34. The latter is mounted to be mobile in rotation and is able to maneuver the clutch lever 36. A clutch 38 is disposed in the kinematic chain between the clutch lever 36 and the intermediate opening lever 10. The clutch 38 is able to assume an engaged configuration in which it allows maneuvering of the intermediate lever 10 by means of the clutch lever or a disengaged configuration in which the clutch lever is unable to maneuver the intermediate lever.

The kinematic chain portions starting from the elements 4 to 8 on the one hand and 30 to 36 on the other hand are distinct and independent of each other. They each independently enable maneuvering of the intermediate opening lever 10 to separate the pawl 14 from the bolt 16, thereby releasing the keeper 18 and thus opening the opening leaf. When it is a question of a maneuver by means of the handle 30, this assumes that the clutch 38 is engaged.

Just like the levers 60 and 64 of the first embodiment, the levers 34 and 36 are mounted to be mobile in rotation relative to the support 20 about the common axis 24, being mobile relative to each other. Here the spring 262, analogous to the spring 162 of the first embodiment, is again disposed between the two parts in the direction of the axis 24 and has its end branches bearing circumferentially on the respective two levers.

Operation conforms to the same principle as in the first embodiment, except that the spring 262 is this time farther downstream in the kinematic chain than in the first embodiment. Thus if the user actuates the exterior handle 30 with their hand, they exert traction on the cable 32 which causes the opening lever 34 to turn about the axis 24. This loading progressively arms the spring 262 and the user must exert an increasing force to continue this arming until the loading is reached that will be transferred by the spring armed in this way to the clutch lever 36. This is the section 48 of the FIG. 4 movement.

During the continuation of the movement, the maneuvering of the handle moves all the parts including the intermediate opening lever 10, the dummy pawl 12, the pawl 14 and the bolt 16, the clutch 38 enabling this transmission of movement.

There are shown in FIG. 8:
the curve 56 relating to the prior art lock,
its straight line segment trend 90 over the section 48, which is greatly raised relative to the horizontal direction, and
the curve 256 corresponding to experimental measurements for the lock of the second embodiment and its associated straight line segment 258, much less raised relative to the horizontal direction than the straight line segment 90.

As previously, the levers 34 and 36 have reliefs enabling them to come to bear directly against each other in order for the lever 34 to be able to maneuver the lever 36 directly assuming that the spring would not on its own enable transmission of the necessary force.

In each of these embodiments, the lock comprises one or more return springs for some of the parts, independent of the springs 162 and 262, these return springs not being inserted in series into the kinematic chain.

Of course, numerous modifications could be made to the invention without departing from the scope thereof. The spring could be placed at different locations in the kinematic chain at will. The spring could for example be disposed:
between two rotary levers of the lock;
in a part of the kinematic chain commandable only from the exterior handle 30 of the opening leaf;
between the handle 4, 30 and the first rotary lever 8, 34 after the handle in the kinematic chain;
upstream of one of the cables 6, 32;
between two levers of the lock upstream of one of the cables 6, 32;
between two sections of one of the cables 6, 32;
downstream of one of the cables 6, 32;
in the handle between a handle mobile part bearing and its drive lever;
between two branches of this drive lever; and
between the clutch lever 36 and the lever 34 upstream of the clutch lever.

At least two springs could also be provided each disposed in series in the kinematic chain.

Moreover, although there has been described hereinabove the use of a flexion type spring, other types of springs may equally be used, for example torsion, compression springs, such as leaf or coil springs.

1. An opening system for a vehicle opening leaf, comprising:
at least one upstream member;
at least one spring; and
at least one downstream member configured to command opening of the opening leaf,
the spring extending in series between the upstream member and the downstream member with reference to a kinematic chain for transmitting a command to open the opening leaf from the upstream member to the downstream member.

2. The system as claimed in claim 1, wherein the upstream member transmits the opening command to the downstream member only via the at least one spring or springs.

3. The system as claimed in claim 1, wherein the upstream member bears directly against the downstream member to transmit the opening command.

4. The system as claimed in claim 1, wherein the at least one spring lies between two rotary levers of the system.

5. The system as claimed in claim 1, wherein the at least one spring lies in a portion of the kinematic chain commandable only from an exterior handle of the opening leaf

6. The system as claimed in claim 1, wherein the at least one spring between a handle and a first rotary lever lies after the handle in the kinematic chain.

7. The system as claimed in claim 1, wherein the at least one spring lies upstream of a cable of a lock.

8. The system as claimed in claim 1, wherein the at least one spring lies between two levers of the system lying upstream of a cable of a lock.

9. The system as claimed in claim 1, wherein the at least one spring lies between two sections of a cable of a lock.

10. The system as claimed in claim 1, wherein the at least one spring lies downstream of a cable of a lock.

11. The system as claimed in claim 1, further comprising a lock, wherein the spring or at least one of the springs lies between a clutch lever of the lock and a lever of the lock lying upstream of the clutch lever.
